(19) United States
(12) Patent Application Publication
(10) Pub. No.: US 2008/0017138 A1
(43) Pub. Date: Jan. 24, 2008

(54) Cooling System

(75) Inventor: Stefan Rogg, Stuttgart (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/597,328

(22) PCT Filed: May 24, 2005
(86) PCT No.: PCT/EP05/05591

§ 371 Date: Nov. 22, 2006

(30) Foreign Application Priority Data
May 26, 2004 (DE) 10 2004 026 328.0

(51) Int. Cl. F01P 7/02; B60K 11/08

(52) U.S. Cl. 123/41.05; 180/68.1

(57) ABSTRACT

The invention relates to a cooling system (1) for a motor vehicle (3), comprising at least one heat exchanger (14, 15), in particular an intercooler, which is traversed by a medium, in particular a coolant that is used to cool a motor (9) and which comprises a heat exchanger air-penetration surface that is traversed by an air stream along a first stream path (26) in a first operating mode, in particular a back-pressure mode and is additionally or alternatively traversed by an air stream along a second stream path (24) running through an air conduction unit (20) in a second operating mode, in particular a ventilator mode. The air conduction unit is located between the heat exchanger (14, 15) and the motor (9) and comprises a conduction air-penetration surface. The aim of the invention is to provide a cooling system, in which the cooling air stream is obstructed as little as possible along the first stream path (26) in the first operating mode and which permits the cooling air stream to be conducted along the second stream path (24) with minimal loss. To achieve this, the air-conduction device (20) and the heat exchanger (14, 15) are configured and arranged in such a way that a parallel projection of the conduction air-penetration surface in the longitudinal direction (8) of the vehicle (3) on the plane containing the heat-exchanger air-penetration surface, protrudes at least partly beyond said heat-exchanger air-penetration surface and that a significant part of the heat-exchanger air-penetration surface is not covered by the parallel projection of the conduction air-penetration surface.

The invention relates to a cooling system for a motor vehicle, having at least one heat exchanger, in particular a cooler, which cooler is traversed by a medium, in particular coolant, which serves for example to cool an engine, and which cooler has a heat exchanger air-passage surface which, in a first operating phase, in particular in a so-called ram-pressure mode, is traversed by an air flow along a first air flow path and which, in a second operating phase, in particular in a so-called fan mode, is additionally or alternatively traversed by an air flow along a second air flow path which runs through an air feed device which is arranged between the heat exchanger and the engine and has a feed air-passage surface.

In cooling systems of said type, the air feed device is formed, for example, by a fan. The fan has the task of providing a flow of a sufficient quantity of cooling air through the cooler and the engine bay when the relative wind is not sufficient, for example when the vehicle is traveling slowly or is stationary. The feed volume required of the fan therefore varies greatly depending on the operating state of the vehicle. At low speeds, the pressure build-up necessary for feeding the cooling air flow is provided by the fan. At high speeds, the fan impedes the cooling air flow, resulting in an increased pressure loss. Various measures for reducing the impeding effect of the fan on the cooling air flow are known from the prior art. Cooling systems having cooling air flaps, which open or close as a function of the ram pressure or of the speed of the vehicle in order to influence the cooling air flow, are known from the German laid-open specification DE 43 04 336 A1, the German laid-open specification DE 39 42 010 A1 and the British patent application GB 2311 843 A. The cooling air flaps are opened at high ram pressures, and thus allow the flow resistance caused by the fan and, if appropriate, by a fan frame, to be partially bypassed. Cooling systems in which, in the fan mode, the cooling air flow is discharged laterally by means of fans which are arranged laterally with respect to the throughflow direction of the cooler are known from the international patent application WO 03/013894 A2 and from the European patent application EP 0 919 705 A2.

It is an object of the invention to produce a cooling system for a motor vehicle, having at least one heat exchanger, in particular a cooler, which cooler is traversed by a medium, in particular coolant, which serves for example to cool an engine, and which cooler has a heat exchanger air-passage surface which, in a first operating phase, in particular in a so-called ram-pressure mode, is traversed by an air flow along a first air flow path and which, in a second operating phase, in particular in a so-called fan mode, is additionally or alternatively traversed by an air flow along a second air flow path which runs through an air feed device which has a feed air-passage surface, in which cooling system, on the one hand, the cooling air flow along the first air flow path is impeded to the least possible degree in the first operating phase, and which cooling system, on the other hand, allows low-loss feeding of the cooling air flow along the second air flow path in the second operating phase.

The object is achieved, in a cooling system for a motor vehicle, having at least one heat exchanger, in particular a cooler, which cooler is traversed by a medium, in particular coolant, which serves for example to cool an engine, and which cooler has a heat exchanger air-passage surface which, in a first operating phase, in particular in a so-called ram-pressure mode, is traversed by an air flow along a first air flow path and which, in a second operating phase, in particular in a so-called fan mode, is additionally or alternatively traversed by an air flow along a second air flow path which runs through an air feed device which has a feed air-passage surface, in that the air feed device and the heat exchanger are designed and arranged in such a way that a parallel projection of the feed air-passage surface in the longitudinal direction of the vehicle onto the plane in which the heat exchanger air-passage surface is situated protrudes at least partially beyond the heat exchanger air-passage surface, and in that a significant part of the heat exchanger air-passage surface is not overlapped by the parallel projection of the feed air-passage surface. It has been established in the context of the present invention that, in the known cooling systems, it is often the case that one or more fans block most of the cooler air-passage surface. The known lateral arrangement of fans results in the cooling air flow having to be deflected a number of times, and having to cover a relatively long flow path to reach the fans. The eccentric arrangement of the air feed device provides a large surface downstream of the cooler which can be selectively blocked or unblocked by means of a device which controls or regulates the cooling air flow. As a result, the cooling air quantity can be increased at high speeds. Despite the eccentric arrangement of the air feed device, good ventilation of the cooler at slow speeds is ensured since no intense deflection of the cooling air flow is necessary in the fan mode.

One preferred exemplary embodiment of the cooling system is characterized in that the air feed device and the heat exchanger are designed and arranged such that 40% to 70% of the heat exchanger air-passage surface is not overlapped by the parallel projection of the feed air-passage surface. In this way, the cooling air quantity at vehicle speeds of over 100 km/h can be increased by up to 20%, leading to a considerable increase in cooling power.

A further preferred exemplary embodiment of the cooling system is characterized in that a device for controlling the air flow is provided in the region between the heat exchanger and the engine which is not overlapped by the parallel projection of the feed air-passage surface. The device for controlling the cooling air flow can, at low ambient temperatures, be used to cut off or considerably reduce the cooling air flow in order to allow the engine and, if appropriate, a vehicle passenger compartment to warm up more quickly.

A further preferred exemplary embodiment of the cooling system is characterized in that the device for controlling the air flow comprises a cooling air louver. The cooling air louver is preferably actuated by means of active control. It is alternatively possible to provide ram-pressure-dependent control or regulation.

A further preferred exemplary embodiment of the cooling system is characterized in that the feed air-passage surface is arranged substantially parallel to the heat exchanger air-passage surface. This ensures that no intense deflection of the cooling air flow is necessary along the second air flow path.

A further preferred exemplary embodiment of the cooling system is characterized in that the feed air-passage surface is arranged so as to be inclined relative to the heat exchanger air-passage surface. The angle of inclination is preferably selected such that optimum flow through the cooling system and through the engine bay is ensured without intense deflection of the cooling air flow. In the context of the present invention, it has proven to be particularly advantageous if the angle enclosed by the feed air-passage surface and the heat exchanger air-passage surface is between 10° and 40°.

A further preferred exemplary embodiment of the cooling system is characterized the air feed device comprises at least one axial fan. It is possible to use one fan or a plurality of fans depending on the cooling power requirements.

A further preferred exemplary embodiment of the cooling system is characterized in that the axial fan has a diameter of 250 mm to 400 mm. Diameters outside said range could also be suitable depending on the application.

A further preferred exemplary embodiment of the cooling system is characterized in that the axial fan has a rotational axis which is arranged radially outside the heat exchanger air-passage surface. This arrangement has proven to be particularly advantageous in the context of the present invention.

A further preferred exemplary embodiment of the cooling system is characterized in that the air feed device is enclosed by a fan frame. The fan frame serves to conduct the cooling air flow to the air feed device.

A further preferred exemplary embodiment of the cooling system is characterized in that the fan frame is embodied as a self-supporting unit. This ensures that the fan frame is sufficiently mechanically stable.

A further preferred exemplary embodiment of the cooling system is characterized in that the fan frame has two struts which laterally delimit the device for controlling the air flow. In this way, it is possible for large control surfaces to be integrated into the fan frame without reducing its mechanical stability.

It is also advantageous if the control surface is divided into two parts and a central strut is added between the partial control surfaces in addition to the lateral struts. It is also advantageous if the fan frame has transverse struts above and/or below the control surfaces. Said additional struts provide a high level of stability of the fan frame and reduce the likelihood of the moveable parts of the control surfaces becoming jammed as a result of deformation of the fan frame. The struts which surround the control surfaces can also be formed as borders of the control surfaces.

It is advantageous to design the central strut of air feed devices which have at least two axial fans in such a way that it adjoins the fan frame or the heat exchanger outlet surface in an encircling fashion. This provides stiffening and ensures that, should one of the fans fail, the region divided by the central strut is not influenced by the failure.

A further preferred exemplary embodiment of the cooling system is characterized in that the air flow is conducted to the heat exchanger through at least one air inlet opening in the front section of the motor vehicle. The cooling air flow can, for example, be conducted through a cooler grille having a plurality of air inlet openings.

A further preferred exemplary embodiment of the cooling system is characterized in that the air inlet opening is arranged below a fender in the front section of the motor vehicle. It is advantageous for the cooler to be of relatively small dimensions and for the cooling air flow to be supplied to the cooler through one or more air inlet openings below the fender. This results in a compact design of the cooling system and makes it possible for the cooling air flow to be guided with few deflections. The compact design is possible because the good air supply to the cooler allows the latter to be reduced in size. Restricting the arrangement of the air inlet openings to below the fender is advantageous since this makes it possible to utilize the ram pressure below the fender to increase the cooling air flow. As a result of the arrangement according to the invention of the air inlet opening, installation space is made available in the front region of the motor vehicle which can be used, for example, for pedestrian protection measures, for lowering the hood line or for accommodating other components.

Depending on the vehicle situation and the arrangement of the air feed device, it can be advantageous to utilize air inlet openings above the fender in addition to or instead of the air inlet opening below the fender.

A further preferred exemplary embodiment of the cooling system is characterized in that a parallel projection of the inlet opening counter to the longitudinal direction of the vehicle onto the plane in which the heat exchanger air-passage surface is situated lies within the heat exchanger air-passage surface. This ensures a rectilinear profile of the cooling air flow from the inlet opening to the cooler.

A further preferred exemplary embodiment of the cooling system is characterized in that the parallel projection of the inlet opening counter to the longitudinal direction of the vehicle onto the plane in which the heat exchanger air-passage surface is situated lies within that part of the heat exchanger air-passage surface which is not overlapped by the parallel projection of the feed air-passage surface. This ensures, when the device for controlling the cooling air flow is open, a rectilinear profile of the cooling air flow from the inlet opening to the device for controlling the cooling air flow.

The object stated above is achieved in a motor vehicle having a cooling system by installing a cooling system of the above described type.

Further advantages, features and details of the invention can be gathered from the following description, in which various exemplary embodiments are described in detail with reference to the drawing, in which:

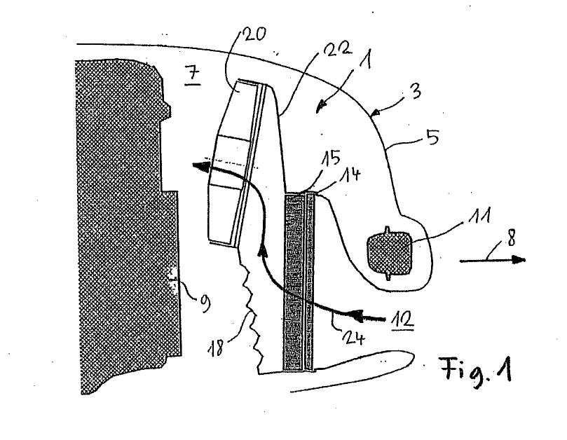

FIG. 1 shows, in a schematic illustration, a section of a first exemplary embodiment of the cooling system according to the invention in the fan mode;

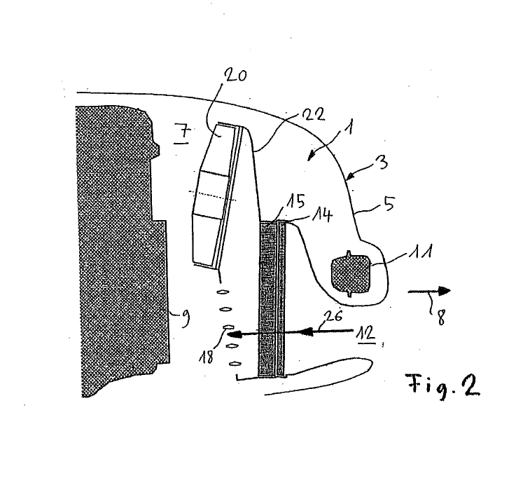

FIG. 2 shows the cooling system from FIG. 1 in the ram pressure mode;

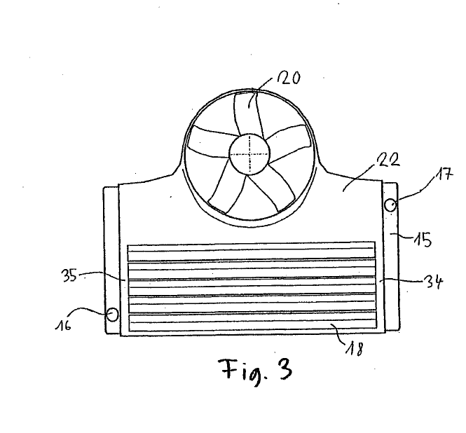

FIG. 3 shows the cooling system from FIG. 1 in a side view, from the left, towards the fan, and

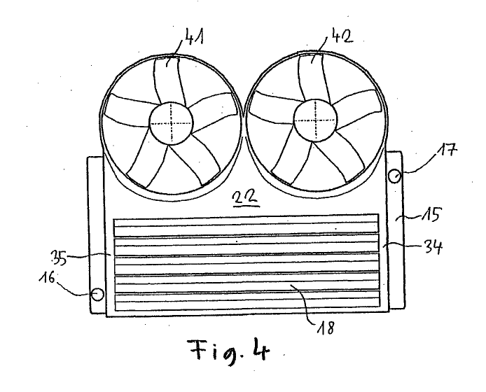

FIG. 4 shows a side view as in FIG. 3, with two fans;

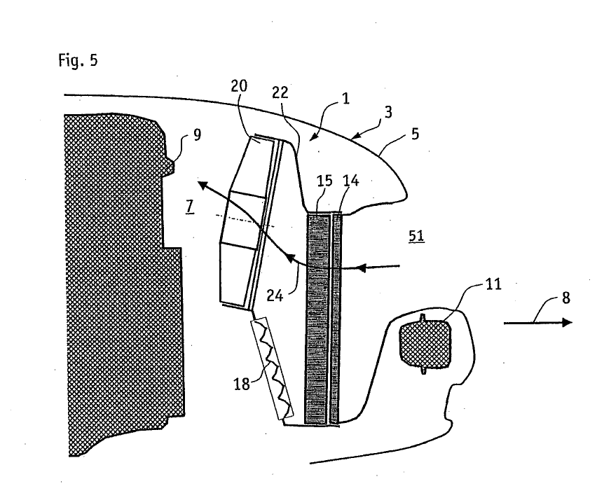

FIG. 5 shows, in a schematic illustration, a section of a second exemplary embodiment of the cooling system according to the invention in the fan mode;

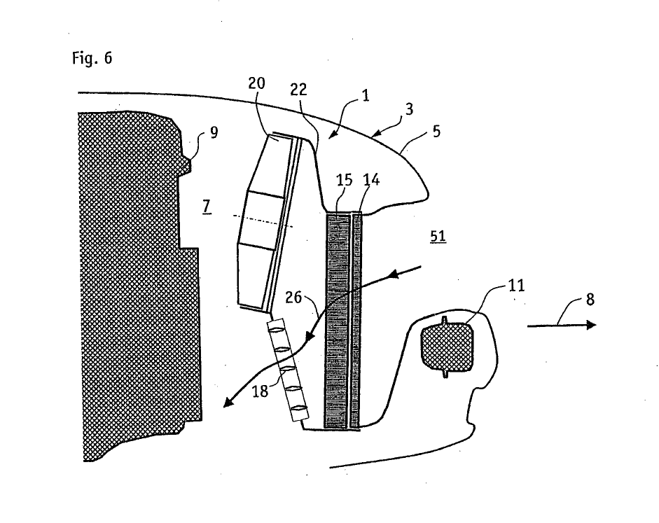

FIG. 6 shows the cooling system from FIG. 5 in the ram pressure mode;

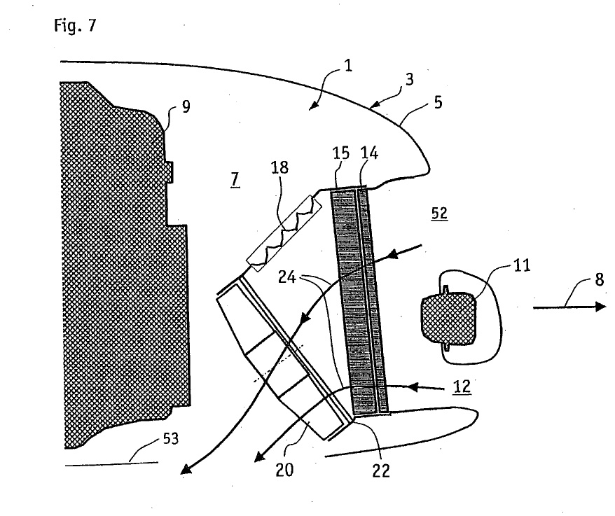

FIG. 7 shows, in a schematic illustration, a section of a third exemplary embodiment of the cooling system according to the invention in the fan mode;

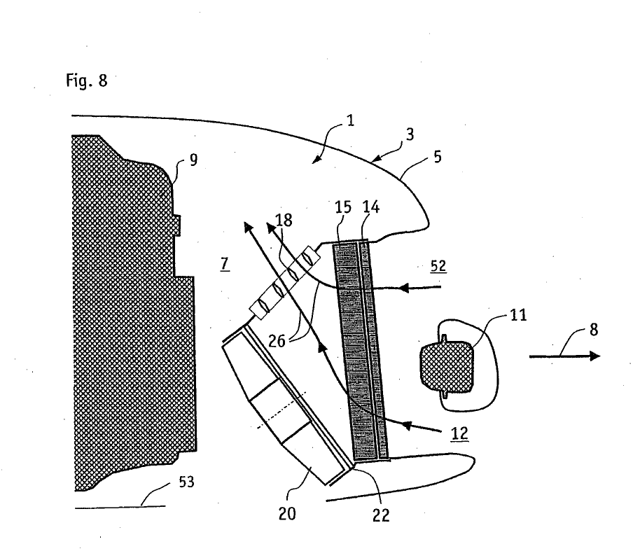

FIG. 8 shows the cooling system from FIG. 7 in the ram pressure mode;

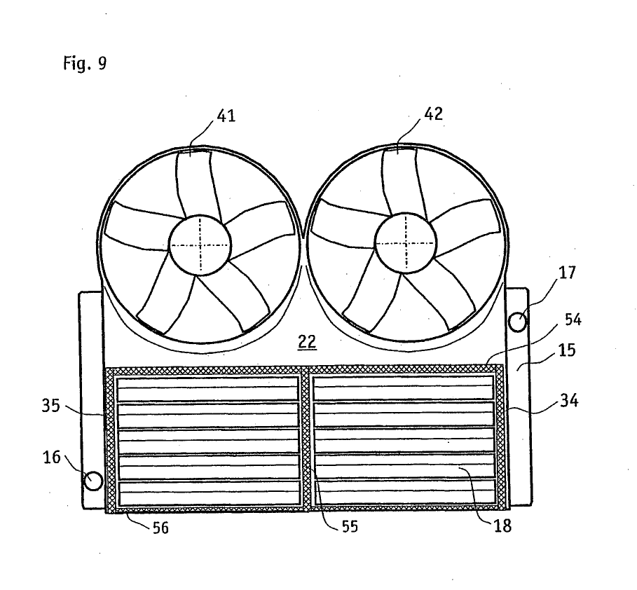

FIG. 9 shows a side view as in FIG. 4, with additional fan frame struts;

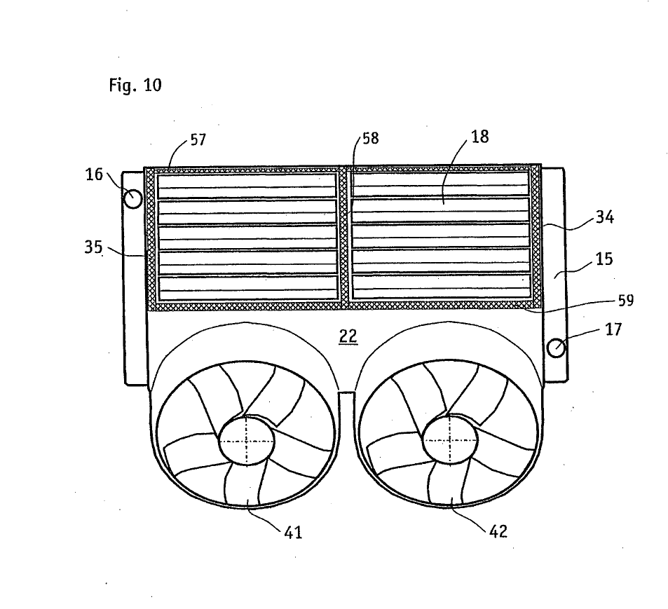

FIG. 10 shows the cooling system from FIG. 7 in a side view, with additional fan frame struts.

The cooling system 1 described in the following can be generally used for vehicles, for example passenger cars, commercial vehicles, buses and the like which have, for example, an internal combustion engine as a drive unit. The cooling system is also directly suitable for electric vehicles or hybrid vehicles.

FIG. 1 shows a diagrammatic sketch of a first exemplary embodiment of the cooling system 1 which is arranged at a front end 5 of a vehicle 3 in an engine bay 7. In the illustration of FIG. 1, the vehicle 3 moves from left to right when driving forwards, as indicated by an arrow 8 which also defines the longitudinal direction of the vehicle. The cooling system 1 is arranged between the engine 9 and the front end 5 of the vehicle 3.

A fender 11 is attached to the front end 5 of the vehicle 3, with an air inlet opening 12 being provided below said fender 11. Instead of one air inlet opening, it is also possible for a plurality of air inlet openings to be provided below the fender 11. The air inlet opening 12 serves to supply a horizontally-running air flow to the cooling system 1 while the vehicle 3 is traveling. The air flow, which is also referred to as a cooling air flow, passes through the air inlet opening 12 to a first heat exchanger 14.

The heat exchanger 14 or the arrangement of a plurality of heat exchangers 14 is composed of, or formed by, for example, a charge air cooler and/or a condenser and/or other heat exchangers of an air conditioning system. The heat exchanger 14 has a connecting piece via which a medium passes into the heat exchanger 14, and at least one further second connecting piece via which the medium leaves the heat exchanger again. The design and function of a heat exchanger 14 of said type are generally known, so these are not explained in any more detail here. During operation, the air flow supplied via the air inlet opening 12 flows through the heat exchanger 14. Here, the air flow passes into the front side of the heat exchanger 14 and out of the rear side of the heat exchanger 14 without being deflected in the heat exchanger. This means that the air flow which flows horizontally to the heat exchanger 14, and impinges substantially perpendicularly on the front side of the heat exchanger, flows substantially rectilinearly through the heat exchanger 14 and passes out of the heat exchanger again at the rear side.

At that side of the heat exchanger 14 which faces the internal combustion engine 9, there is a further heat exchanger 15 between the internal combustion engine 9 and the heat exchanger 14, said further heat exchanger 15 being formed by a cooler which, as shown in FIGS. 3 and 4, has a connecting piece 17 via which, for example, a coolant passes into the heat exchanger 15, and at least one further connecting piece 16, through which the coolant passes out again before being guided to the internal combustion engine. Like the heat exchanger 14, the heat exchanger 15, such as a cooler, is traversed horizontally by the cooling air flow.

A cooling air louver 18 is arranged between the heat exchanger 15, such as a cooler, and the internal combustion engine 9. In FIG. 1, the cooling air louver 18 is closed, so that no air passes through the cooling air louver 18 into the engine bay 7. Arranged above the cooling air louver 18 is a fan 20, which protrudes upward beyond the heat exchangers 14 and 15. The fan 20 is enclosed by a fan frame 22 which is also referred to as a fan cowling. The fan frame 22 serves to conduct the air flow, which enters through the air inlet opening 12, to the fan 20. Here, the air flow is conducted past the closed cooling air louver 18, as indicated by an air flow path 24. The cooling air flow is blown into the engine bay 7 by the fan 20.

In FIG. 2, the cooling air louver 18 is in its open position, so that the cooling air flow, as indicated by an air flow path 26, runs rectilinearly from the air inlet opening 12 to the internal combustion engine 9 and beyond.

The air-passage surface of the fan 20 is also referred to as a feed air-passage surface. The air-passage surface of the heat exchangers is also referred to as a heat exchanger air-passage surface. The feed air-passage surface of the fan 20 overlaps the heat exchanger air-passage surface in only a relatively small, substantially circular-segment-shaped region. Approximately 40 to 70 percent of the heat exchanger air-passage surface is overlapped by the cooling air louver 18. The cooling air louver 18 is actuated by means of active control. It is alternatively possible to provide ram-pressure-dependent control.

It can be seen in FIG. 3 that the fan frame 22 is embodied as a self-supporting unit, with primarily the dimensional stability of the fan frame 22 being utilized. The self-supporting unit is supported via two struts 34 and 35 which laterally delimit the cooling air louver 18. This makes it possible for large louver surfaces to be integrated into the fan frame 22 without reducing its mechanical stability.

FIG. 4 illustrates an exemplary embodiment having two fans 41 and 42. Like the fan 20 in FIG. 3, the fans 41, 42 are axial fans, which have a diameter of approximately 300 mm. The two fans 41 and 42 are arranged adjacent to one another horizontally.

FIG. 5 shows a diagrammatic sketch of a second exemplary embodiment of the cooling system 1, which differs from the first exemplary embodiment shown in FIG. 1 in that the air inlet opening 51 is provided above the fender 11. When the cooling air louver 18 is closed, the air flow path 24 runs from the upper air inlet opening 51 to the fan 20.

In FIG. 6, the cooling air louver 18 is in the open position, so that the air flow path 26 runs downwards from the upper air inlet opening 51 to the internal combustion engine 9 and beyond.

FIG. 7 shows a diagrammatic sketch of a third exemplary embodiment of the cooling system 1, which differs from the exemplary embodiments shown in FIGS. 1 and 2 in that the fan 20 is arranged not above but below the cooling air louver 18. The fan 20 accordingly protrudes not upward but downward beyond the heat exchangers 14 and 15. In FIG. 7, air inlet openings 12, 52 are provided above and below the fender. When the cooling air louver 18 is closed, the air flow path 24 runs in each case from the upper and the lower air inlet opening to the fan 20. Here, the air flow path from the upper air inlet opening 52 to the fan 20 is preferred, because it involves smaller deflections of the cooling air. With regard to the discharge of the cooling air downstream of the fan 20, it is advantageous if there are openings in the vehicle floor 53 through which the air flow can leave the engine bay 7.

FIG. 8 shows the exemplary embodiment from FIG. 7, with the cooling air louver 18 open. In this position, the air flow path 26 runs upwards from the upper and lower air inlet openings to the internal combustion engine 9 and beyond. Here, the air flow path from the lower air inlet opening 12 to the open cooling air louver is preferred, because it involves smaller deflections of the cooling air.

FIG. 9 illustrates how the dimensional stability of the fan frame 22 in the region of the cooling air louver can be further improved in order to prevent distortion of the substantially planar surface covered by the cooling air louver. Limiting the distortion is important for the free movement of the moveable elements of the cooling air louver. For this purpose, transverse struts 54, 56 are added above and below the cooling air louver. For yet further stabilization, the cooling air louver is divided into two part-area cooling air louvers, and a central strut 55 is added between the part-area cooling air louvers. The central strut 55 provides a maximum stabilization action if the central strut 55, like the lateral struts 34 and 35, extends over the full height of the fan frame 22 and runs as far as the heat exchanger 15. The central strut 55 then assumes, if appropriate, the shape of the lateral projection of the fan frame 22.

The transverse struts 54, 56 and if appropriate the central strut 55 form, together with the lateral struts 34 and 35, a border of the cooling air louver or of the part-area cooling air louvers, as can be seen in FIG. 9. Said border can be an integral constituent of the fan frame 22 or of the cooling air louver 18, wherein in the latter case, the cooling air louver with the border is mounted into a fan frame without a border.

FIG. 10 shows the stiffening by means of struts 34, 35, 57, 58, 59 for the fan frame 22 as used in the arrangement according to FIG. 7 and FIG. 8. Said arrangement can substantially be gathered from FIG. 9 by exchanging the positions of the axial fans 41, 42 and of the fan frame 18 together with the border.

1. A cooling system for a motor vehicle, having at least one heat exchanger, in particular a cooler, which cooler is traversed by a medium, in particular coolant, which serves for example to cool an engine, and which cooler has a heat exchanger air-passage surface which, in a first operating phase, in particular in a so-called ram-pressure mode, is traversed by an air flow along a first air flow path and which, in a second operating phase, in particular in a so-called fan mode, is additionally or alternatively traversed by an air flow along a second air flow path which runs through an air feed device which is arranged between the heat exchanger and the engine and has a feed air-passage surface, wherein the air feed device and the heat exchanger are designed and arranged in such a way that a parallel projection of the feed air-passage surface in the longitudinal direction of the vehicle onto the plane in which the heat exchanger air-passage surface is situated protrudes at least partially beyond the heat exchanger air-passage surface, and in that a significant part of the heat exchanger air-passage surface is not overlapped by the parallel projection of the feed air-passage surface.

2. The cooling system as claimed in claim 1, wherein the air feed device and the heat exchanger are designed and arranged such that 40% to 70% of the heat exchanger air-passage surface is not overlapped by the parallel projection of the feed air-passage surface.

3. The cooling system as claimed in claim 1, wherein a device for controlling the air flow is provided in the region between the heat exchanger and the engine which is not overlapped by the parallel projection of the feed air-passage surface.

4. The cooling system as claimed in claim 3, wherein the device for controlling the air flow comprises a cooling air louver.

5. The cooling system as claimed in claim 1, wherein the feed air-passage surface is arranged substantially parallel to the heat exchanger air-passage surface.

6. The cooling system as claimed in, claim 1, wherein the feed air-passage surface is arranged so as to be inclined relative to the heat exchanger air-passage surface.

7. The cooling system as claimed in claim 1, wherein the air feed device comprises at least one axial fan.

8. The cooling system as claimed in claim 7, wherein the axial fan has a diameter of 250 mm to 400 mm.

9. The cooling system as claimed in claim claim 7, wherein the axial fan has a rotational axis which is arranged radially outside the heat exchanger air-passage surface.

10. The cooling system as claimed in claim 1, wherein the air feed device is enclosed by a fan frame.

11. The cooling system as claimed in claim 10, wherein the fan frame is embodied as a self-supporting unit.

12. The cooling system as claimed in claim 10, wherein the fan frame has two struts which laterally delimit the device for controlling the air flow.

13. The cooling system as claimed in claim 10, wherein the fan frame has an upper and/or a lower transverse strut which delimits the device for controlling the air flow at the top and/or at the bottom.

14. The cooling system as claimed in claim 10, wherein the device for controlling the air flow is divided into two parts, and the fan frame has a central strut in the separating plane.

15. The cooling system as claimed in claim 13, wherein a border of the device for controlling the air flow having struts is part of the fan frame.

16. The cooling system as claimed in claim 13, wherein a border of the device for controlling the air flow having struts is part of the device for controlling the air flow.

17. The cooling system as claimed in claim 1, wherein the air flow is conducted to the heat exchanger through at least one air inlet opening in the front section of the motor vehicle.

18. The cooling system as claimed in claim 17, wherein the air inlet opening is arranged below a fender in the front section of the motor vehicle.

19. The cooling system as claimed in claim 17, wherein the air inlet opening is arranged above a fender in the front section of the motor vehicle.

20. The cooling system as claimed in claim 17, wherein air inlet openings are arranged above and below a fender in the front section of the motor vehicle.

21. The cooling system as claimed in claim 18, wherein a parallel projection of the inlet opening counter to the longitudinal direction of the vehicle onto the plane in which the heat exchanger air-passage surface is situated lies within the heat exchanger air-passage surface.

22. The cooling system as claimed in claim 21, wherein the parallel projection of the inlet opening counter to the longitudinal direction of the vehicle onto the plane in which the heat exchanger air-passage surface is situated lies within that part of the heat exchanger air-passage surface which is not overlapped by the parallel projection of the feed air-passage surface.

23. A motor vehicle having a cooling system as claimed in claim 1.
